(19) United States
(12) Patent Application Publication
(10) Pub. No.: US 2002/0138245 A1
(43) Pub. Date: Sep. 26, 2002

(54) Communication simulation apparatus and method

(75) Inventor: Takeshi Yasuda, Kobe-shi (JP)

Correspondence Address: OLIFF & BERRIDGE, PLC, P.O. BOX 19928, ALEXANDRIA, VA, 22320, US

(73) Assignee: FUJITSU TEN LIMITED, Kobe-shi (JP)

(21) Appl. No.: 10/104,028

(22) Filed: Mar. 25, 2002

(30) Foreign Application Priority Data
Mar. 26, 2001 (JP) 2001-088180

(51) Int. Cl. G06F 17/50

(52) U.S. Cl. 703/19

(57) ABSTRACT

In generation of communication data, continuous data capable of being acquired by a data logger is set as original data and the original data is sampled every a timing period t inputted. Since the original data and timing of sampling are displayed on the same screen, it can visually be checked which portion of the original is sampled and sent. In the timing of sampling, an initial point can be shifted. Assuming urgent time such as abnormal occurrence, a sending point for sampling the original data and generating and sending the communication data can be inputted and set at the time other than the sampling period t.

### BACKGROUND OF THE INVENITON

1. Field of the Invention

The present invention relates to a communication simulation apparatus and a method for being used in adjustment at the time of development or manufacture of a control system constructed by combining a plurality of electronic control units and simulating data communication between the electronic control units.

2. Description of the Related Art

Conventionally, for example, a plurality of electronic control units are mounted in an automobile, and engine control, driving control, safety control and driver support are performed. It is constructed so that each the electronic control unit is abbreviated as ECU and mounts a microcomputer and shares or overlaps control functions to enable backup and improves safety. For example, as the engine control, fuel injection control abbreviated as EFI, ignition timing control abbreviated as ESA and idle revolution control abbreviated as ISC are performed. It is necessary for cooperation of control between the ECUs with the same control target and the mutual ECUs are connected through a communication line and data communication is conducted. Data of engine revolution speed is transmitted by data communication even between the ECUs with different control targets, for example, engine control and driving control.

In the case of developing plural ECUs mounted in an automobile, individual ECUs are first developed respectively and further adjustment at a combined state is made as the whole system. However, in order to make the development or adjustment surely and efficiently, the development can be advanced more efficiently by making the adjustment so that cooperation with another ECU is enabled even in a stage in which the ECUs are developed individually. Also, in the case of producing the ECUs after the development is completed, a function of data communication is desirably inspected or adjusted efficiently in the individual ECUs singly.

FIG. 10 shows a control system by two ECUs basically obtained by simplifying a control system constructed of plural ECUs. In this system, data calculated by an ECU-A is sent to an ECU-B. Since each the ECU is an electronic control unit including a microcomputer, adjustment or verification of operation can be made using a logic analyzer as disclosed in, for example, JP-A-6-139095 as a logic circuit. An object of this related art is to be able to freely set timing for inputting and outputting a logic signal and make a cause analysis of a malfunction of a peripheral IC of a microcomputer system speedily and accurately.

Incidentally, related arts about a test of a semiconductor integrated circuit mounted in an ECU are disclosed in, for example, JP-A-5-133998 or JP-A-6-30784U. In these related arts, timing of signal sending for making measurement or test can be set. Also, in a digital oscilloscope which is a general-purpose measuring device, as disclosed in, for example, JP-A-6-82573U, data stored in waveform memory can be two-dimensionally sampled and displayed according to timing directed from the outside.

Development of an ECU for vehicle is advanced in parallel with development of an engine etc. targeted for control. Therefore, the ECU needs to advance the development before an actual control target is present, and an artificial signal generator as disclosed in, for example, JP-A-5-288115, is used. The artificial signal generator of this related art is constructed so that parameters of artificial signals given to an engine control unit for performing centralized control of fuel injection, ignition and the number of revolution of idling can be freely set and changed.

When the ECU-B as shown in FIG. 10 is developed, there is often a case that an actual ECU-A is absent in the field of design or evaluation. In this case, a designer of the ECU-B requires an artificial ECU such as a communication simulator in which an output equivalent to that of the ECU-A is produced. Here, it is assumed that the ECU-A calculates data as shown by a dotted line in FIG. 11, and a case of sending this data every t time is assumed. In the ECU-A, continuous data like vehicle speed is normally calculated and handled. When the calculated data is sent to the ECU-B, the data is sent out on a communication line every t time. When it is assumed that slope-shaped continuous data changing in triangular shape as shown by the dotted line of FIG. 11 is calculated in the ECU-A, data sent to the ECU-B becomes data changing in step shape as shown by a solid line.

A signal used in the logic analyzer or the test of the semiconductor integrated circuit is a continuous analog signal or digital signal. An artificial signal given to the engine control unit is also a continuous signal. However, communication data used in data communication between the ECUs is discrete data. In the discrete data, data itself as well as timing for sending out the data to the communication line become important.

Generally, as a method for constructing communication data for simulation, a method for setting communication timing and data at that time as two-dimensional data of a format of a table form is known. But, in such a method, the number of man-hours is necessary to input all the data. On the other hand, the continuous analog signal or digital signal can be defined as continuous time series data by a function, so that a dedicated data creation tool is also known.

Data sent discretely with timing as shown FIG. 11 can be inputted every sending timing t by a general-purpose tool such as a trademark name “EXCEL” for handling data of a table form. Since a waveform of FIG. 11 is a relatively simple example, it may not feel inconvenient for creation of the data of the table form. However, for more complicated data, generally, it is not easy to create data every t time. When control of an actual automobile is assumed, it is readily assumed that data becomes a more complicated waveform. Also, as a targeted time becomes longer and a sending timing period becomes shorter, the number of data to be set increases and difficulty increases.

When development of the ECU for automobile is assumed, there is often a case that targeted data is not the simple data as shown in FIG. 11. Also, the continuous data can be collected from things which have already been present by some method, for example, have actually been acquired by a data logger, or it is expected that the continuous data can be created by another tool. Further, it is desired that sending timing can be defined simply based on the continuous data.

### SUMMARY OF THE INVENTION

An object of the invention is to provide a communication simulation apparatus and method in which acquisition of original data is easy and a definition of sending timing is simple.

According to the invention, there is provided a communication simulation apparatus for artificially generating discrete communication data and sending the data on a communication line, comprising original data setting means capable of setting previously generated continuous data as original data, timing input means for inputting a timing period for sending communication data, and data sending means for performing sampling from the original data set to the original data setting means and generating the communication data and sending the data on the communication line according to the timing period inputted to the timing input means.

In the original data setting means, previously generated continuous data can be set as original data. A timing period for sending communication data is inputted to the timing input means. The data sending means performs sampling from the original data set to the original data setting means and generates the communication data and sends the data on the communication line according to the timing period inputted to the timing input means, so that the original data can be defined easily and the number of man-hours necessary for the case of inputting the communication data in a table form every sending timing in order to generate discrete data can be reduced. When the timing period inputted to the timing input means is changed, the communication data can be generated and sent at a different timing period without changing the original data.

Input for shifting an initial point of the timing period can be done to the timing input means.

When an initial point of the timing period inputted to the timing input means is shifted, the communication data can be sent with different timing even in the case that a period for conducting data communication is the same. Since the communication data is discrete, in the communication data generated based on a waveform including a peak value, it is considered that a data value to be sent varies largely depending on sending timing. By shifting the initial point of the timing period, comparison between a case that the peak value is sent and a case that the peak value is not sent can be made easily.

A point in time of sending of the communication data as well as the timing period can arbitrarily be inputted to the timing input means, and the datas ending means determines whether the point in time of sending inputted to the timing input means is reached or not while sampling the original data and generating and sending the communication data according to the timing period and performs sampling of the original data, generation and sending of the communication data at the time of reaching said point in time of sending.

The communication data can be sent at an arbitrary point in time of sending as well as the timing period inputted to the timing input means, so that test or adjustment corresponding. to occurrence of an urgent event such as the time of a sudden change in data other than sending with regular timing can be made.

Further included is waveform display means for displaying a waveform of the original data set to the original data setting means as an image and displaying timing of sampling by the data sending means on the same screen as that of said waveform.

According to the invention, a waveform of the original data set to the original data setting means is displayed on the waveform display means as an image. Timing with which the data sending means samples the original data based on the timing period inputted to the timing input means is displayed on the same screen as that of the waveform, so that it can visually be checked which portion of the original data the communication data is generated and sent from.

Timing display of the sampling is performed as a signal waveform indicated by the communication data.

Timing display of sampling with respect to the original data is performed on a screen of the waveform display means by a signal waveform indicated by the communication data sampled and generated, so that an image of data receiving of the side receiving the communication data can be checked easily.

Further included is data modification means capable of making a modification to a different data value every timing of each the sampling with respect to a waveform of the original data displayed on the waveform display means, and the data sending means sends modified data with timing in which a data value is modified by the data modification means.

When data is modified by the data modification means, data deviating from the original data can be sent.

According to the invention, there is provided a communication simulation method characterized in that artificial communication data is generated from a communication simulation apparatus as defined in any of the above descriptions and at least one of test or adjustment of a data communication function provided by electronic equipment is made.

By setting the original data and inputting the timing period, test or adjustment of a data communication function provided by electronic equipment can be made easily and efficiently.

According to the invention, there is provided a program for causing a computer to function as a communication simulation apparatus as defined in any of the above descriptions.

It can be operated as a communication simulation apparatus in which the original data can be set by causing a computer to read a program and sampling is performed from the original data every the timing period inputted and the communication data is sent.

### BRIEF DESCRIPTION OF THE DRAWINGS

FIG. 1 is a block diagram showing a schematic electrical configuration of a communication simulation apparatus 1 as one embodiment of the present invention.

FIG. 2 is a graph showing a continuous waveform of original data stored in an original data storage section 12 of FIG. 1.

FIG. 3 is a flowchart showing a simulation procedure using the communication simulation apparatus 1 of FIG. 1.

FIG. 4 is a graph showing a waveform of original data and sampling timing displayed by a display device 7 of FIG. 1.

FIG. 5 is a graph showing the waveform of the original data and the sampling timing displayed by the display device 7 of FIG. 1.

FIG. 6 is a graph showing the waveform of the original data and the sampling timing displayed by the display device 7 of FIG. 1.

FIG. 7 is a graph showing the waveform of the original data and the sampling timing displayed by the display device 7 of FIG. 1.

FIG. 8 is a graph showing the waveform of the original data, modified data and the sampling timing displayed by the display device 7 of FIG. 1.

FIG. 9 is a graph showing the waveform of the original data and a step-shaped waveform corresponding to the sampling timing displayed by the display device 7 of FIG. 1.

FIG. 10 is a block diagram simplifying and showing a configuration of a system formed between two ECUs for conducting data communication.

FIG. 11 is a graph showing original data of a simple continuous waveform and a step-shaped data waveform formed by receiving discrete communication data.

### DETAIELD DESCRIPTION OF THE PRESENT INVENTION

The present invention will be described in detail with reference to the accompanying drawings.

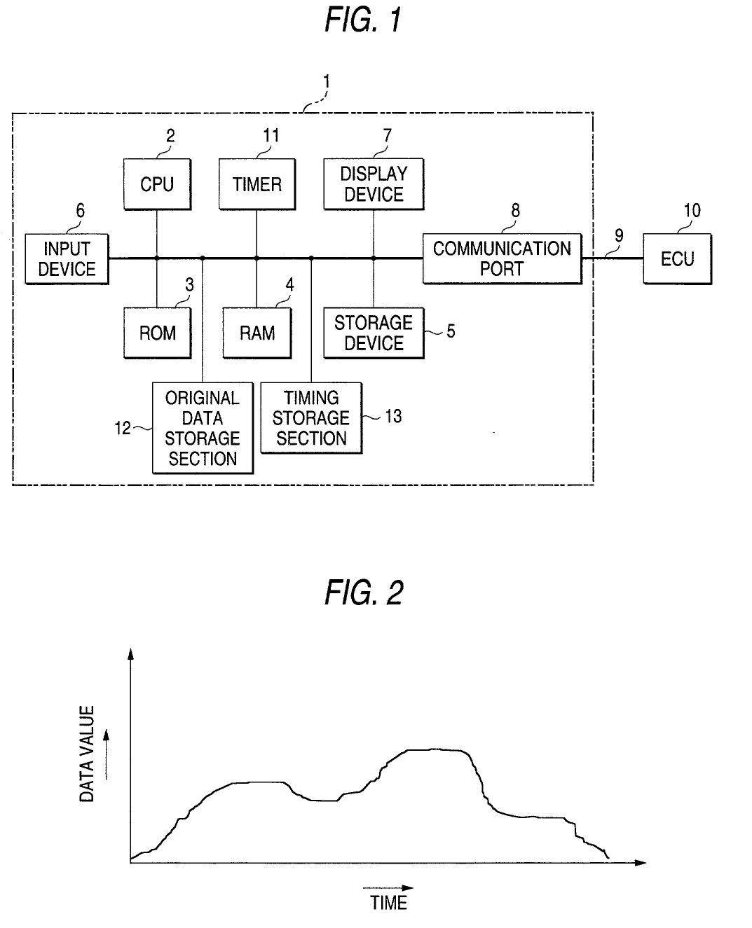

FIG. 1 shows a schematic configuration of a communication simulation apparatus 1 as one embodiment of the invention. The communication simulation apparatus 1 of the present embodiment is a general-purpose computer basically, and a CPU 2 operates according to programs stored in ROM 3 or RAM 4. In the ROM 3, basic programs are stored and an operation system may be stored. The operation system can be constructed so as to be read to the RAM 4 from a storage device 5 using a hard disk or a removable record medium. A program acting as the communication simulation apparatus 1 is read out on the RAM 4 from the storage device 5 as an application program operating on the operation system. Incidentally, an operating program previously created can be stored in the ROM 3 as the dedicated communication simulation apparatus 1.

The communication simulation apparatus 1 of the embodiment comprises an input device 6 such as a keyboard or a mouse, a display device 7 such as a cathode ray tube (CRT) or a liquid crystal display (LCD) device, and a communication port 8. An ECU 10 of a target for making test, inspection or adjustment can be connected to the communication port 8. A timer 11 which becomes a standard of time operation is further included in the communication simulation apparatus 1, and an original data storage section 12 and a timing storage section 13 are provided in the RAM 4 or the storage device 5.

The communication simulation apparatus 1 of the embodiment artificially generates discrete communication data and sends the data on a communication line 9. The input device 6 and the original data storage section 12 function as original data setting means capable of setting previously generated continuous data as original data. The input device 6 and the timing storage section 13 function as timing input means for inputting a timing period for sending communication data. The CPU 2 functions as data sending means for performing sampling from the original data set to the original data setting means and generating the communication data and sending the data on the communication line 9 according to the timing period inputted to the timing input means.

FIG. 2 shows an example of continuous original data. Though it is very difficult to input such data in a table form, it is easy to acquire by a data logger in the case of data which is present actually. The previously generated continuous data can be stored in the original data storage section 12 of FIG. 1 as original data. The continuous original data can be used by collecting data generated in actual control by the data logger. The data can be drawn and generated on a graphic screen. The timing period for sending communication data is stored in the timing storage section 13 in the case of doing input as a numeric value. The CPU 2 acting as the data sending means performs sampling from the original data stored in the original data storage section 12 and generates the communication data and sends the data on the communication line 9 according to the timing period stored in the timing storage section 13. As a result of this, the number of man-hours necessary for the case of inputting the communication data in a table form every sending timing in order to generate discrete data can be reduced. When input is done to the input device 6 and the timing period stored in the timing storage section 13 is changed, the communication data can be generated and sent at a different timing period without changing the original data.

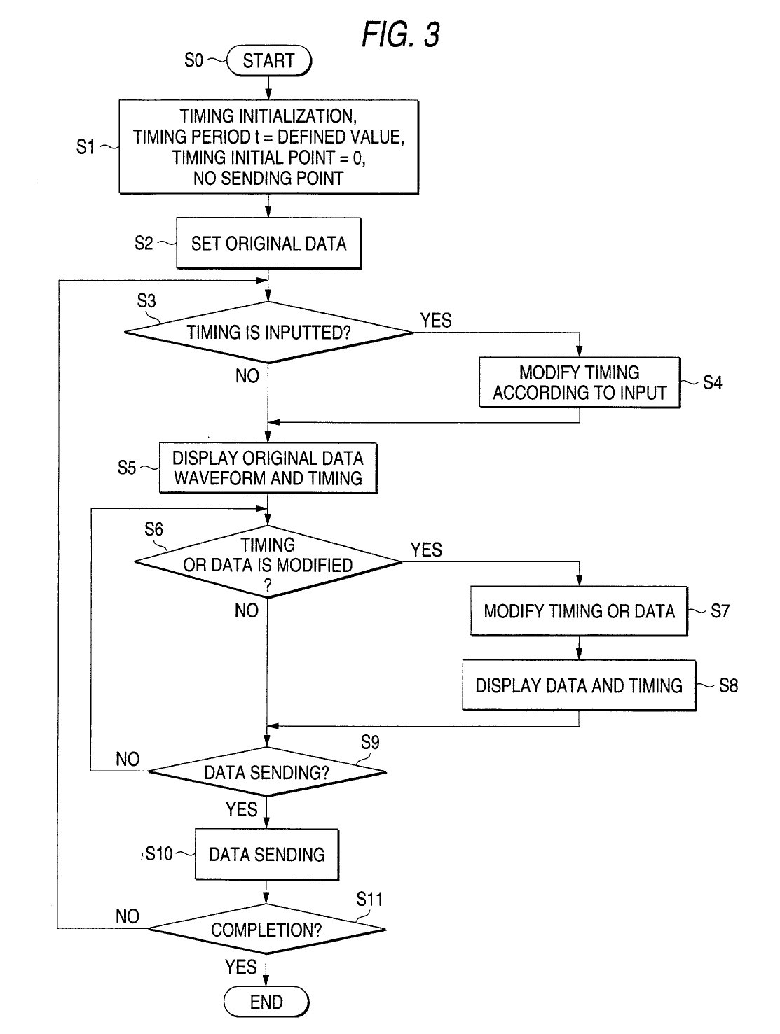

FIG. 3 shows a procedure of communication simulation performed by the communication simulation apparatus 1 of the embodiment. A procedure is started from step s0 and in step s1, timing for sending original data is initialized. In the initialization of the timing, a timing period t of sampling is set to a defined value and a timing initial point is set to zero and a sending point other than the timing period t is not set. In step s2, continuous data which becomes original data is set to the original data storage section 12 of FIG. 1. In step s3, it is determined whether or not input about timing from a user of the communication simulation apparatus 1 is done to the input device 6. When timing is inputted, in step s4, an initial value about timing is modified according to the input. When it is determined that timing is not inputted in step s3, or after step s4 is completed, an original data waveform and timing is displayed on the display device 7 in step s5.

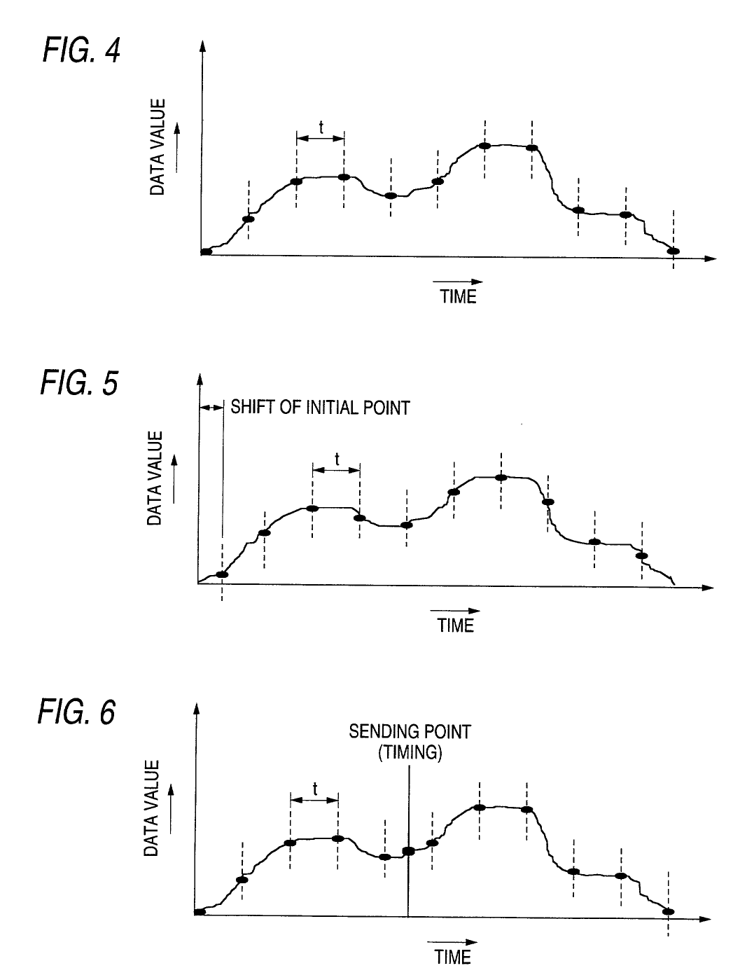

FIG. 4 shows a state in which the original data of FIG. 2 and a time axis cursor every the sampling period t are displayed on the same screen. That is, a waveform of the original data stored in the original data storage section 12 is displayed as an image and also timing for sampling the original data based on the timing period t stored in the timing storage section is displayed on the display device 7 acting as waveform display means, so that it can visually be checked which portion of the original data the communication data is generated and sent from.

FIG. 5 shows a display screen of the case of doing input for shifting a timing initial point in step s3 of FIG. 3. When an initial point of the timing period t stored in the timing storage section 13 is shifted, the communication data can be sent with different timing even in the case that a period for conducting data communication is the same. Since the original data is continuous and the communication data is discrete, in the communication data generated based on a waveform including a peak value, a case that the peak is sent and a case that the peak is not sent occur depending on sending timing and a data value to be sent may vary largely. By shifting the initial point of the timing period, comparison between the case that the peak value is sent and the case that the peak value is not sent can be made easily.

FIG. 6 shows a display screen of the case of doing input for adding a sending point other than the timing period in step s3 of FIG. 3. In this case, it is determined whether a sending point which is a point in time of sending stored in the timing storage section 13 is reached or not while sampling the original data and generating and sending the communication data according to the timing period t. At the time of reaching the point in time of sending, sampling of the original data and generation and sending of the communication data are performed even at the time other than the timing period t. After passing the sending point, the communication data is sent at the timing period t. When the sending point is added, the communication data can be sent at an arbitrary point in time of sending as well as the timing period t stored in the timing storage section, so that test or adjustment corresponding to occurrence of an urgent event such as the time of a sudden change in data other than sending with regular timing can be made.

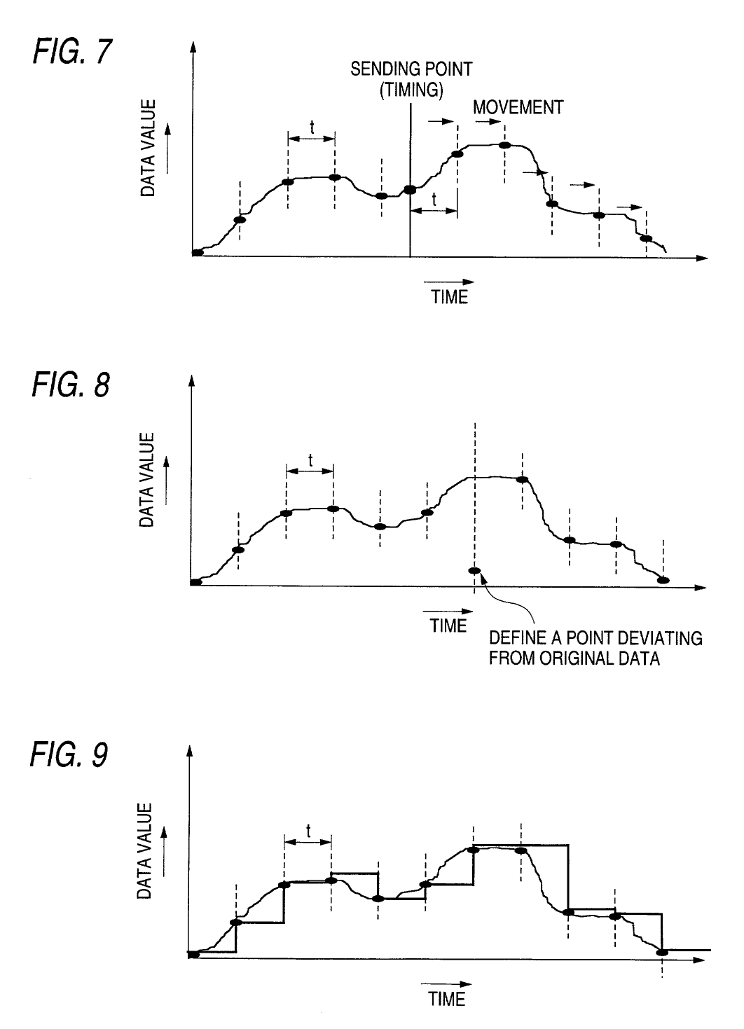

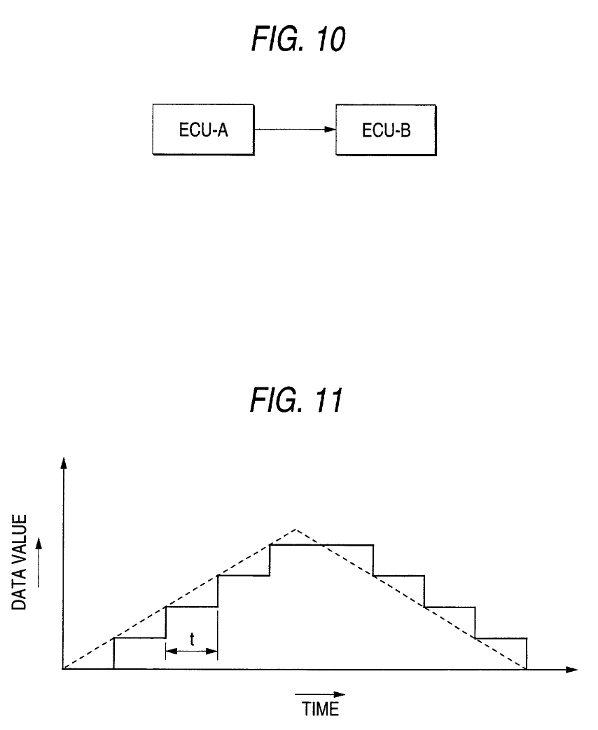

FIG. 7 shows a function of automatically moving so that data is sent every the timing period t stored in the timing storage section 13 using a sending point as a new initial point after making addition for inserting a sending point in a manner similar to FIG. 6. Either the function or a function of continuing the original period t and inserting only a sending point as shown in FIG. 6 can be selected.

When display in step s5 of FIG. 3 is completed, it is determined whether timing or data is modified or not in step s6. When it is determined that it is modified, the timing or data is modified in step s7. The modification of the timing is made in a manner similar to step s4. Instep s8, the modified timing or data is displayed.

FIG. 8 shows a state of defining a point in which data is modified and deviates from the original data in step s8 of FIG. 3. In the case that data deviating from the original data want to be sent, when a mouse of the input device 6 is operated with respect to a screen displayed in step s5, it becomes the display of step s8 through steps s6 and s7 of FIG. 3, and sending data can be modified later every sending timing.

When it is determined that the timing or data is not modified in step s6 of FIG. 3, or after the display in step s8 is completed, an instruction about whether data sending is performed or not in step s9 is waited. When there is no instruction for performing the data sending, the procedure returns to step s6, and the procedure from step s6 to step s9 is repeated below. When the data sending is instructed in step s9, in step s10, the original data is sampled and the communication data is generated and the data sending is performed at the timing period t or the sending point. When the data sending of step s10 is completed, an instruction about whether communication simulation is completed or not in step s10 is waited. When there is no instruction of the completion, the procedure returns to step s3 and when there is the instruction of the completion, the procedure is ended in step s12.

FIG. 9 shows an example in which timing display of sampling displayed on the display device 7 as an image is performed by a step-shaped signal waveform indicated by discrete communication data. Since timing display of sampling with respect to the original data is performed on a screen of the display device 7 which is the waveform display means by a signal waveform indicated by the communication data sampled and generated, an image of data received by the ECU 10 of the side receiving the communication data can be checked easily.

Though the communication simulation apparatus 1 of the embodiment provides each the function described above, all the functions may be not necessarily provided, and a function in which setting of original data and input of a timing period are enabled and the set original data is sampled at the inputted timing period and communication data is generated and sent may be provided. Other functions can be provided by any combinations. When such a communication simulation apparatus 1 is used, artificial communication data can easily be generated to make test, inspection or adjustment of a data communication function provided by electronic equipment such as the ECU 10 or other information terminal equipment. Further, as shown in the embodiment, by causing a computer to function as the communication simulation apparatus 1 by a program, proper communication simulation can be performed by a general-purpose computer.

As described above, according to the invention, sampling can be performed from original data to generate communication data and send the data on a communication line according to a timing period inputted. Continuous data acquired by a data logger can be used as the original data, and there is no need to input the communication data in a table form every sending timing in order to generate discrete data, and a definition is simplified and the number of man-hours necessary for data input can be reduced. When the timing period inputted is changed, the communication data can be generated and sent at a different timing period without changing the original data.

Also, according to the invention, the communication data can be sent with different timing by shifting an initial point of the timing period even in the case that a period is the same. In discrete communication data generated based on a waveform including a peak value, a data value may vary largely depending on sending timing and an influence of the peak value can be examined easily by shifting the initial point of the timing period.

Also, according to the invention, the communication data can be sent at an arbitrary point in time of sending, so that test or adjustment corresponding to occurrence of an urgent event such as the time of a sudden change in data other than sending with regular timing can be made.

Also, according to the invention, a waveform of the original data and timing for sampling the original data are displayed on the same screen, so that it can visually be checked which portion of the original data the communication data is generated and sent from.

Also, according to the invention, a waveform of the original data and a signal waveform indicated by the communication data sampled and generated are displayed on the same screen, so that an image of data receiving of the side receiving the communication data can be checked easily.

Also, according to the invention, even for data different from the original data, data can be modified and sent easily.

Further, according to the invention, by setting the original data and inputting the timing period, test or adjustment of a data communication function in development or production of electronic equipment can be made easily and efficiently.

Furthermore, according to the invention, test or adjustment of electronic equipment providing a data communication function can be made easily and efficiently by operating even a general-purpose computer as a communication simulation apparatus in which the original data can be set by reading a program and sampling is performed from the original data every the timing period inputted and the communication data is sent.

What is claimed is:

1. A communication simulation apparatus for artificially generating discrete communication data and sending the data on a communication line, the apparatus comprising:
original data setting means for setting in advance generated continuous data as original data thereto;
timing input means for inputting therein a timing period for sending communication data; and
data sending means for performing sampling from the original data set to the original data setting means, generating the communication data and sending the data on the communication line according to the timing period inputted therein the timing input means.

2. The communication simulation apparatus as defined in claim 1, wherein the timing input means shifts an initial point of the timing period.

3. The communication simulation apparatus as defined in claim 1, wherein the timing input means inputs a sending timing of the communication data therein;
the data sending means determines that the sending timing inputted therein is reached while sampling the original data and generating and sending the communication data according to the timing period; and
the data sending means performs sampling of the original data, generation and sending of the communication data at the time of reaching the sending timing.

4. The communication simulation apparatus as defined in claim 1, further comprising waveform display means for displaying a waveform of the original data set to the original data setting means as an image, the waveform display means for displaying timing of sampling by the data sending means on the same screen as that of the waveform.

5. The communication simulation apparatus as defined in claim 4, wherein the timing of the sampling is displayed as a signal waveform indicated by the communication data.

6. The communication simulation apparatus as defined in claim 4, further comprising data modification means for modifying a waveform of the original data displayed on the waveform display means to a different data value every timing of each sampling to generate modified data; and
the data sending means sends the modified data with timing in which a data value is modified by the data modification means.

7. The communication simulation method comprising:
generating artificial communication data from a communication simulation apparatus; and
making at least one of test or adjustment of a data communication function provided by electronic equipment,
wherein the communication simulation apparatus artificially generates discrete communication data and sends the data on a communication line;
the communication simulation apparatus comprises:
original data setting means for setting in advance generated continuous data as original data thereto;
timing input means for inputting therein a timing period for sending communication data; and
data sending means for performing sampling from the original data set to the original data setting means, generating the communication data and sending the data on the communication line according to the timing period inputted therein the timing input means.

8. A program for causing a computer to function as a communication simulation apparatus, the communication simulation apparatus comprising:
original data setting means for setting in advance generated continuous data as original data thereto;
timing input means for inputting therein a timing period for sending communication data; and
data sending means for performing sampling from the original data set to the original data setting means, generating the communication data and sending the data on the communication line according to the timing period inputted therein the timing input means.
